(19) United States
(12) Patent Application Publication
(10) Pub. No.: US 2016/0255357 A1
(43) Pub. Date: Sep. 1, 2016

(54) FEATURE-BASED IMAGE SET COMPRESSION

(71) Applicant: MICROSOFT TECHNOLOGY LICENSING, LLC, Redmond, WA (US)

(72) Inventors: Xiaoyan Sun, Beijing (CN); Feng Wu, Beijing (CN); Zhongbo Shi, Beijing (CN)

(21) Appl. No.: 14/905,599

(22) PCT Filed: Jul. 15, 2013
(86) PCT No.: PCT/CN2013/079352

§ 371 Date: Jan. 15, 2016

(51) Int. Cl. H04N 19/426; H04N 19/51; H04N 19/65; G06K 9/52; H04N 19/136; G06K 9/62

(52) U.S. Cl. CPC H04N 19/426; H04N 19/136; G06K 9/6218; H04N 19/65; G06K 9/52; H04N 19/51

(57) ABSTRACT

Some examples may generate one or more sets of compressed images from an image collection. Images from the image collection may be clustered into one or more sets of images based on one or more features in each image. A minimum spanning tree of images may be created from each of the one or more sets of images based on the one or more features in each image. Feature-based prediction may be performed using the feature-based minimum spanning tree. One or more sets of compressed images corresponding to the one or more sets of images may be generated.

### BACKGROUND

People may store and/or share multiple digital images (e.g., photographs) with other people (e.g., friends and/or relatives). Depending on the size of the images, storing these images may use a large amount of storage space. If the multiple digital images may be compressed with little, if any, perceivable loss of image quality, the multiple digital images may be stored using less storage space and/or may be transmitted over a communications network using less bandwidth. If digital images may be stored using less space and/or transmitted more easily, people may share additional digital images with other people.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some examples described herein may generate one or more sets of compressed images from an image collection. Images from the image collection may be clustered into one or more sets of images based on one or more features in each image. A minimum spanning tree of images may be created from each of the one or more sets of images based on the one or more features in each image. Feature-based prediction may be performed using the feature-based minimum spanning tree. One or more sets of compressed images corresponding to the one or more sets of images may be generated.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an illustrative architecture that includes an image collection according to some implementations.

FIG. 2 is a flow diagram of an example process that includes outputting an encoded bitstream according to some implementations.

FIG. 3 is an illustrative architecture that includes a feature-based minimum spanning tree according to some implementations.

FIG. 4 is a flow diagram of an example process of a prediction algorithm according to some implementations.

FIG. 5 is a flow diagram of an example process that includes receiving an image collection according to some implementations.

FIG. 6 is a flow diagram of an example process that includes clustering images according to some implementations.

FIG. 7 is a flow diagram of an example process that includes generating a minimum spanning tree according to some implementations.

FIG. 8 illustrates an example configuration of a computing device and environment that may be used to implement the modules, techniques, and functions described herein.

### DETAILED DESCRIPTION

The systems and techniques described herein may be used to compress a collection of digital images (also referred to herein as “images”). Compressing a set of one or more images may include removing redundancy between images (e.g., inter-image redundancy or set redundancy) and removing redundancy within a particular image (e.g., intra-image redundancy or image redundancy). The systems and techniques described herein utilize a compression scheme to remove inter-image redundancy based on local features and luminance values. A SIFT (Scale Invariant Feature Transform) descriptor may be used to characterize an image region in a way that may be invariant to scale and rotation of one or more objects in the image region. The SIFT descriptor may be used to measure and further enhance correlation among images. Given an image set, a minimal cost prediction structure is built according to the SIFT-based prediction measure between images. In addition, a SIFT-based global transformation may be used to enhance correlation between two or more images by aligning the two or more images to each other in terms of both geometry and intensity. The set redundancy as well as image redundancy may be further reduced by block-based motion estimation and rate-distortion optimization (RDO). The systems and techniques described herein may be used to compress a collection of digital images regardless of the properties of the image sets.

Thus, the image set compression techniques described herein may be used to create a compact representation of a set of correlated visual data to enable transmission and storage of correlated image sets, such as tomographic images and multispectral pictures. The compact representation may be achieved by reducing redundancy inside an image set (e.g., set redundancy) in addition to reducing redundancy within each image (e.g., image redundancy). For example, the techniques described herein may be used to compress a set of images that include rotations of objects and zooming. A SIFT-based image set compression technique which uses SIFT descriptors may be used to evaluate the similarity between two images. In addition, when coding two or more images, the two or more images may be aligned to each other in terms of geometry as well as intensity rather than merely using one image as a basis for prediction.

### Illustrative Architecture

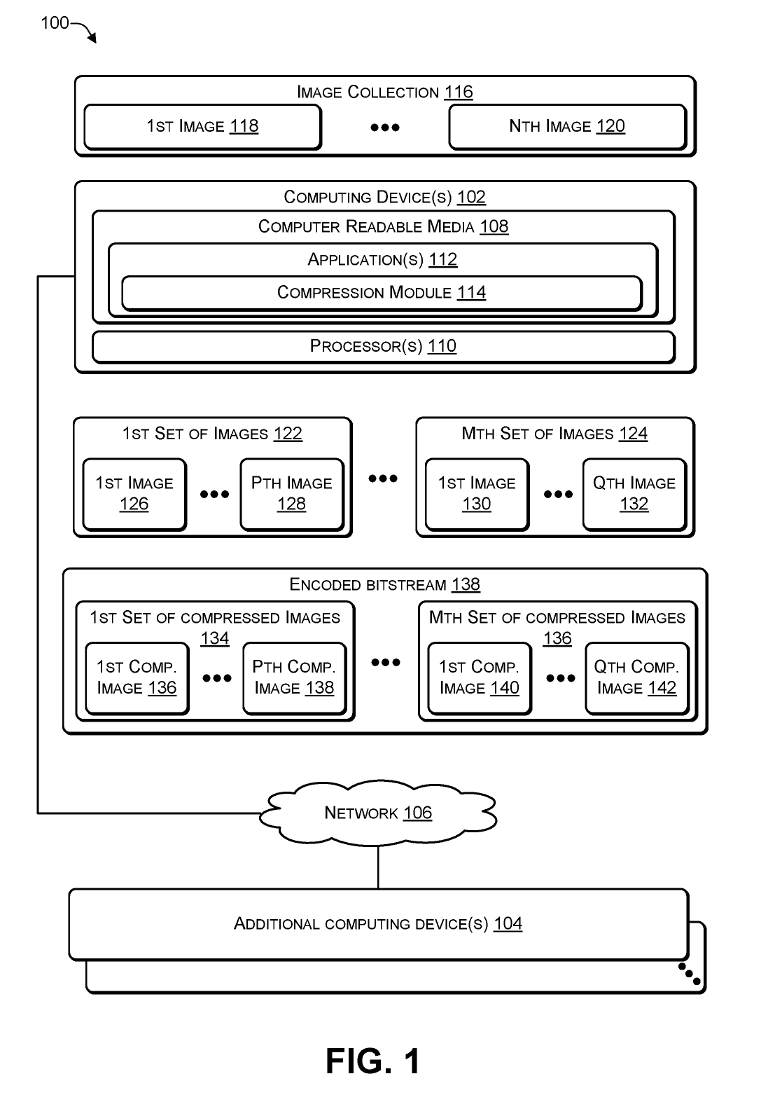

FIG. 1 is an illustrative architecture 100 that includes an image collection according to some implementations. The architecture 100 includes one or more computing devices 102 coupled to one or more additional computing devices via a network 106.

The computing device 102 may include one or more computer readable media 108 and one or more processors 110. The computer readable media 108 may include one or more applications 112, such as a compression module 114. The applications 112 may include instructions that are executable by the one or more processors 110 to perform various functions. For example, the compression module 114 may include instructions that are executable by the one or more processors 110 to compress an image collection 116 that includes multiple sets of images using the techniques described herein.

The image collection 116 may include N images (where N>0), such as a first image 118 to an Nth image 120. The images in the image collection 116 may include digital images in one or more image file formats, such as (but not limited to) joint picture experts group (JPEG), tagged image file format (TIFF), RAW (or other lossless formats), graphics image format (GIF), bitmap (BMP), portable networks graphics (PNG), or the like. At least some of the images in the image collection 116 may include at least a portion of a same object. For example, an individual who goes on a vacation may take digital images (e.g., photographs) that include a landmark (e.g., the Statue of Liberty, the Eiffel Tower, the Taj Mahal, the Great Wall of China, etc.) or a particular person (e.g., a spouse, a child, a relative, or other person with whom the individual has a relationship). To illustrate using a landmark, the digital images may include the landmark from different angles and/or different vantage points. Some of the digital images may be zoomed in or closeup to provide a detailed view of a particular portion of the landmark and/or zoomed out to provide the landmark within a context of the landmark's surroundings.

The compression module 114 may group the N images 118 to 120 from the image collection into sets of digital images that each include one or more digital images. The N images 118 to 120 may be grouped based on features. For example, a feature may include one or more objects that are common to (e.g., included in) a subset of the images. For example, the compression module 114 may group the N images 118 to 120 into M sets of images (where M>0), such as a first set of images 122 to an Mth set of images 124. Each of the M set of images may include one or more images. The first set of images 122 may include P images (where P>0), from a 1st image to a Pth image while the Mth set of images 124 may include Q images (where Q>0 and Q need not be equal to P), from a first image 130 to a Qth image 132. The first set of images 122 may each include a feature, such as at least a portion of a same object (e.g., a landmark, a person, etc.). Similarly, the Mth set of images may each include another feature, such as at least a portion of another object (e.g., a landmark, a person, etc.).

The compression module 114 may compress the M sets of images 122 to 124 to create corresponding sets of compressed images, including a first set of compressed images 134 to an Mth set of compressed images 136. For example, the first set of compressed images 134 may correspond to the first set of images 122 while the Mth set of compressed images 136 may correspond to the Mth set of images 124. The first set of compressed images 134 may include P compressed images 138 to 140 corresponding to the P images 126 to 128. The Mth set of compressed images 136 may include Q compressed images 142 to 144 corresponding to the Q images 130 to 132. The M sets of compressed images 134 to 136 may include images that have been compressed by reducing inter-image redundancy and/or by reducing intra-image redundancy. In some cases, the compression module 114 may generate an encoded bitstream 138 that includes the M sets of compressed images 134 to 136.

The compression module 114 may be used in a variety of situations. For example, an individual may use one or more of the computing devices 102 to store the image collection 116 in a compressed format. As another example, the individual may use one or more of the computing devices 102 to store the M sets of compressed images 134 to 136 as a backup of the image collection 116. In these examples, the computing devices 102 may include a personal computer (e.g., desktop, laptop, tablet device, wireless phone, camera, or the like) and/or a cloud-based storage service. The individual may share at least a portion of the M sets of compressed images 134 to 136 with additional individuals associated with the additional computing device(s) 104 via the network 106.

Thus, the compression module 114 may be used to group images in the image collection 116 into the M sets of images 122 to 124. The compression module 114 may reduce inter-picture redundancy and/or intra-picture redundancy to create the M sets of compressed images 134 to 136. In some cases, the M sets of compressed images 134 to 136 may be in the form of an encoded bitstream.

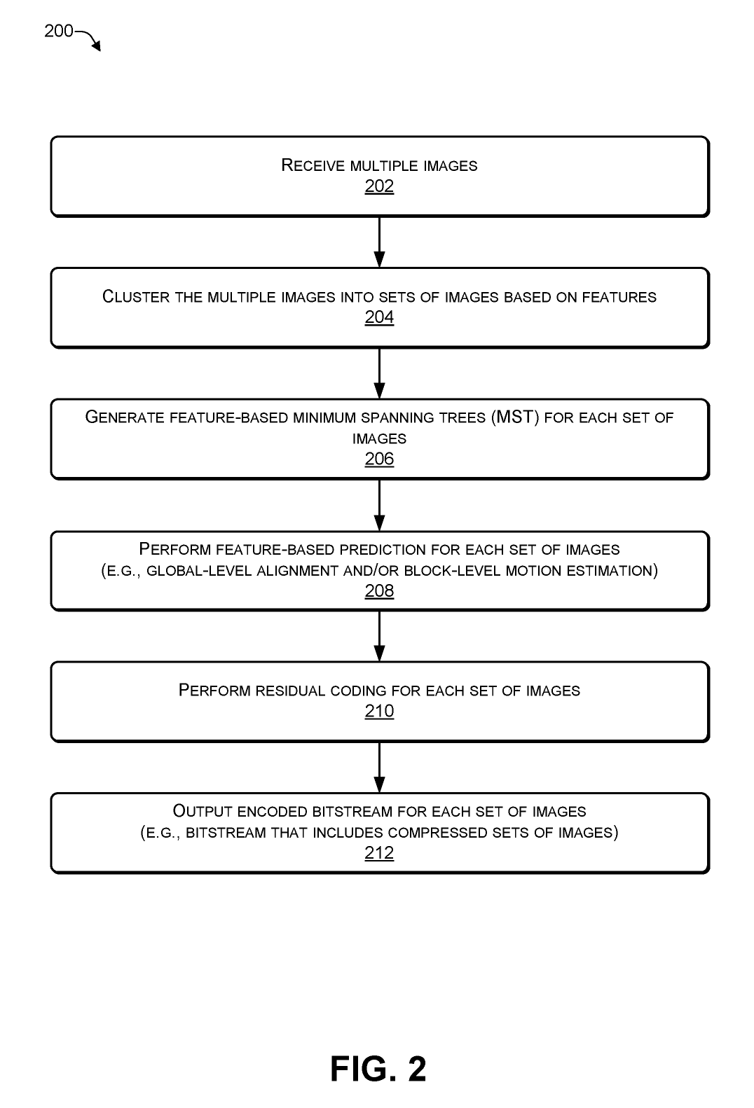

FIG. 2 is a flow diagram of an example process 200 that includes outputting an encoded bitstream according to some implementations. The process 200 may be performed by the compression module 114 of FIG. 1.

A generic image set, such as one of the set of images 122 to 124, may include images collected from different points and different view angles at different locations. A compression scheme to compress a generic image set may automatically (e.g., without human interaction) set up a prediction structure based on correlations between the images. In some cases, the correlations may be determined using a disparity function (e.g. mean squared error (MSE)) in the pixel domain. Disparity functions in the pixel domain may be effective when the relationship among images is very close (e.g., the images are very similar). However, disparity functions may not be invariant to scale, rotation and other geometric deformations. In addition, disparity functions may be easily affected by shelter and illumination variance.

Instead of using disparity functions, the compression module 114 may use a temporal correlation between two or more images in a feature domain, in which a distance of image features may be used to measure a disparity between images. For example, the image features may include a SIFT feature as a correlation measure. Let F₁ represent the set of SIFT descriptors of image I. Each SIFT feature fᵢεF_{I}, may be defined as

fᵢ={gᵢ,xᵢ,sᵢ,oᵢ}, (1)

where gᵢ is a 128 dimensional (128D) gradient vector representing local image gradients in a region around an i^{th} key-point xᵢ=(xᵢ,yᵢ), and (xᵢ,yᵢ), sᵢ and oᵢ represent spatial coordinates, scale and dominant gradient orientation of the i^{th} key-point, respectively. The key-point positions of image I may be determined by finding a maxima and a minima of a result of a difference of Gaussians function applied to a series of smoothed and hierarchically down-sampled images.

At 202, multiple images may be received. For example, in FIG. 1, the compression module 114 may receive the image collection 116. In some cases, the image collection 116 may be received along with an instruction to compress the image collection 116.

At 204, the multiple images may be clustered into sets of images based on features identified and/or included in each image. For example, in FIG. 1, the compression module 114 may cluster (e.g., group) the N images 118 to 120 to create the M sets of images 122 to 124. The compression module 114 may cluster the N images 118 to 120 based on features associated with each of the N images 118 to 120. For example, a disparity may be determined (e.g., calculated) between any two images in the image collection 116 based on a distance of SIFT features from the two images. The set may be divided into the M sets of images 122 to 124 based on SIFT disparities.

At 206, a feature-based minimum spanning trees (MST) may be generated for each set of images. For example, in FIG. 1, for each of the sets of images 122 to 124, a SIFT-based MST may be generated to determine a prediction structure.

At 208, feature-based prediction may be performed for each set of images. For example, in FIG. 1, a global-level alignment estimation may be used to reduce image-level scale and rotation distortion. As another example, block-level motion estimation may be used to reduce local shifts.

At 210, residual coding may be performed for each set of images. For example, prediction residuals may be encoded for each image of the sets of images 122 to 124.

At 212, an encoded bitstream may be output for each set of images. For example, the feature-based prediction along with the encoded residual may be output as an encoded bitstream that includes the sets of compressed images 134 to 136.

Thus, for an image collection that includes generic (e.g., random, non-specific) images, the disparity between any two images in the image collection may be determined by a distance of SIFT features from the two images. The collection may be divided into sets of images according to SIFT disparities. For each set of images, a SIFT-based MST may be generated to determine the prediction structure. Prediction mechanisms, such as global level alignment and block level motion estimation, may be used to reduce image-level scale and rotation distortion and local shifts, respectively. In this way, the image collection 116 may be compressed into an encoded bitstream that includes the sets of compressed images 134 to 136.

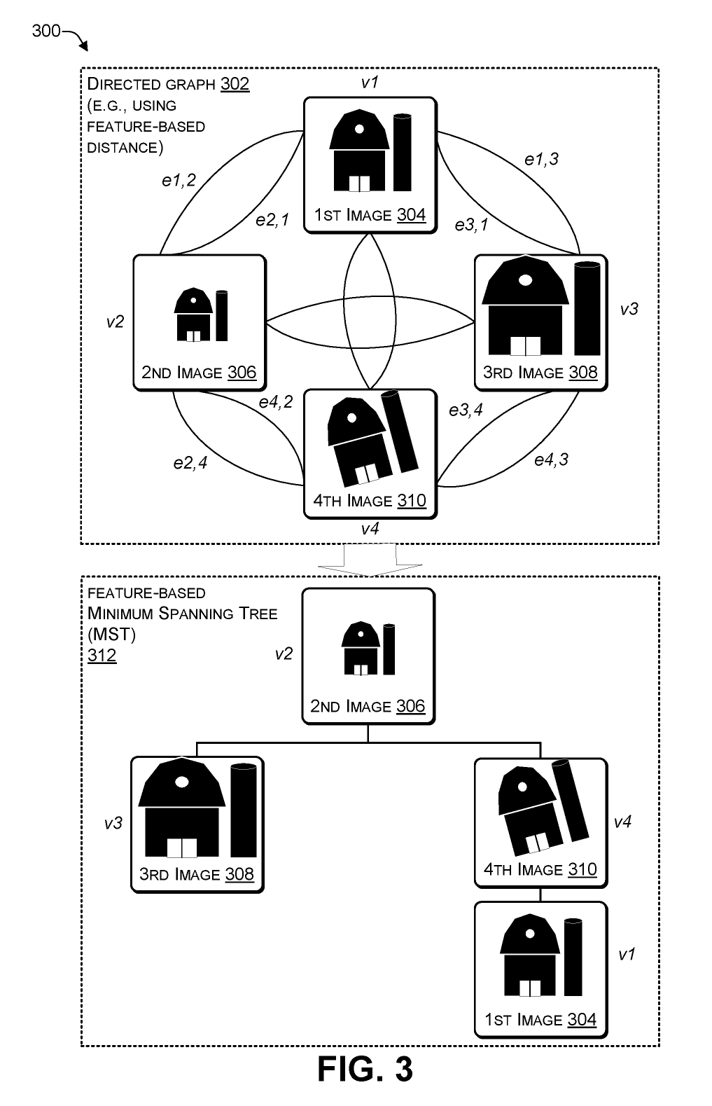

FIG. 3 is an illustrative architecture 300 that includes a feature-based minimum spanning tree (MST) according to some implementations. The feature-based MST may be generated by the compression module 114 of FIG. 1.

Generally, a correlation between images from different scenes may be limited. For example, there may be little or no correlation between a photograph of the Statue of Liberty and a photograph of the Eiffel Tower. If an input image collection (e.g., the image collection 116) includes different images from different scenes, dividing the images into multiple sets based on the content of each image may enable inter-image redundancy reduction within each set because each set may include images having some degree of correlation.

The compression module 114 may use a modified k-means clustering algorithm. K-means clustering is a method of cluster analysis used to partition n observations into k clusters in which each observation belongs to the cluster with the nearest mean. First, a set of SIFT descriptors from an image may be used to represent a set of 128 dimension (e.g., 128D) gradient vectors of the image. The set of SIFT descriptors may provide a feature-domain representation of the image. The distance between two elements may be defined as an average absolute distance of matched 128D gradient vectors. Second, a centroid of each cluster may include a central group of descriptors. The centroid may be selected from an image which has a minimum average distance to the other images in the same cluster. Based on these two modifications, the k-mean algorithm results in the m sets 122 to 124. The number of sets m may be selected by a user (e.g., user specified input to the compression module 114) or calculated according to a cluster separation measure expressed as:

$$ρ ( n ) = \frac{1}{n} {\sum }_{i = 1}^{n} {max}_{1 \leq j \leq n ⋀ i \neq j} ( \frac{{ɛ}_{i} + {ɛ}_{j}}{{μ}_{ij}} ) , where n > 2 \qquad ( 2 )$$

where εᵢ and εⱼ denote average distance of element images and their corresponding centroids in i^{th} and j^{th} subsets, respectively and μᵢⱼ denotes a distance between two centroids. Determine ρ(n) for

$$2 \leq n \leq \frac{N}{10}$$

and select an optimal nₒₚₜ clusters by minimizing ρ(n), where N is the total number of input images in the image collection 116. Other image features (e.g. gist and color features), geography information (e.g. global positioning system (GPS)), and tags marked by users may be further utilized to help with clustering images into sets of images. The gist may be a model representing a dominant spatial structure of a scene in an image.

A prediction structure for image set compression may achieve an optimal prediction path by minimizing an overall rate-distortion cost of the image set. The correlation between images inside a set of images may be represented as a directed graph 302. The directed graph 302 may include a first image 304, a second image 306, a third image 308, and a fourth image 310. The direct graph 302 may be expressed as G=(V, E), where each node vᵢεV denotes an image, and each edge e_{i,j}εE denotes a cost between i^{th} and j^{th} images. A MST of G may be a directed sub-graph, which has a smallest total costs using a real rate-distortion coding cost. However, optimal MST generation process with an overall rate-distortion measure may be a non-deterministic polynomial time (e.g., NP-hard) problem. In some cases, the cost may be approximated by a prediction measure between two neighboring images, such as root mean square error (RMSE) or strict similarity (SSIM). The compression module 114 may use a SIFT-based prediction measure in which a SIFT distance calculated in a prior clustering process is used as an edge cost e_{i,j} to determine a feature-based prediction tree in which the total feature distance is minimized.

As illustrated in FIG. 3, a feature-based MST 312 may be generated for each subset based on the graph structure. MST 312 illustrates that the prediction of v₃ and v₄ is v₂ and the prediction of v₁ is v₄ and v₂. Note that the root of each MST may be determined automatically (e.g., without human interaction) by the MST searching algorithm.

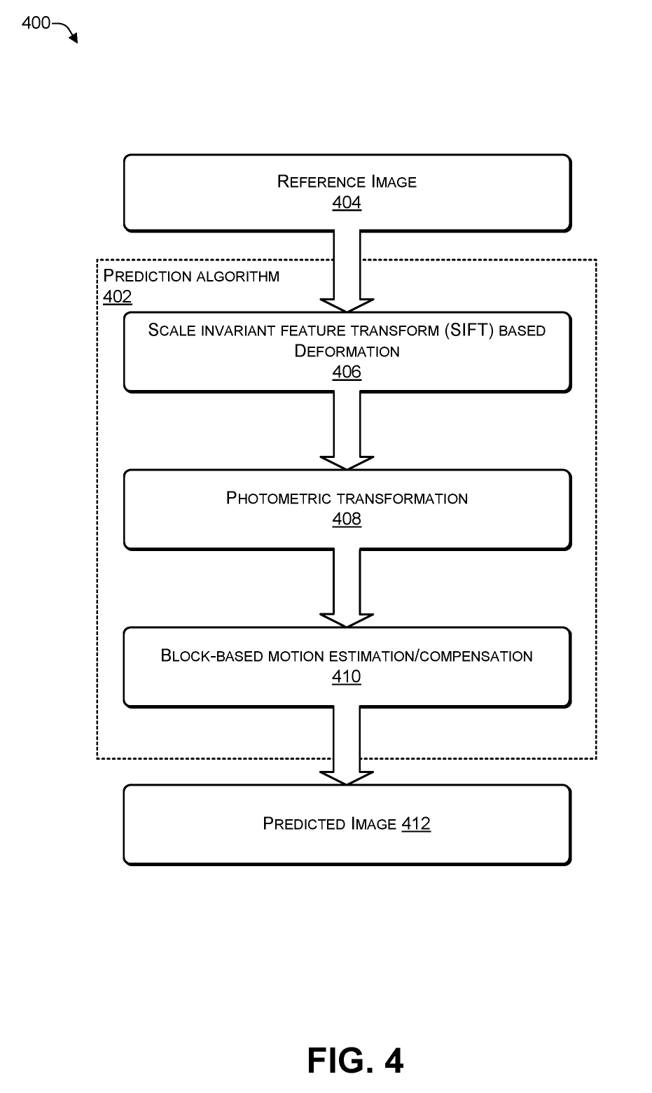

FIG. 4 is a flow diagram of an example process 400 of a prediction algorithm according to some implementations. For example, the compression module 114 of FIG. 1 may use the process 400 that includes a prediction algorithm 402 to determine a predicted image.

After determining a MST for each set of images 122 to 124, redundancy may be reduced for each of the images in a particular set based on the MST. For example, the MST 312 of FIG. 3 may be used to code the root image v₂ as an intra-image without any prediction. After the root image v₂ is reconstructed, inter-image prediction may be performed to generate a prediction image for coding v₃ and v₄. The image v₁ may then be predicted from v₄ and v₂.

In contrast to inter-image prediction schemes used in video coding and conventional image set compression, the compression module 114 may use two prediction mechanisms, global-level alignment and block-level motion estimation, for inter-image prediction. Global alignment may include both a SIFT-based deformation 406 and a photometric transformation 408. The SIFT-based deformation 406 may be used to reduce geometric distortions caused by different locations and different camera positions. The photometric transformation 408 may be used to reduce variations in brightness. The block-level motion estimation may include block-based motion estimation/compensation 410. The block-based motion estimation/compensation 410 may reduce local pixel shifts to improve an accuracy of predictions. For example, when performing feature-based prediction, a deformed predicted image may not be precisely aligned to a corresponding original image. If the alignment is not precise, local distortions, in the form of local pixel shifts, may be present. The block-based motion estimation/compensation 410 may reduce the local pixel shifts to more closely align the deformed predicted image with the original image.

The transformation from one camera plane to another camera plane may be modeled as a homograph transform, which uses 3D matched coordinates to solve a transform matrix. Because the depth coordinate of the camera plane may not be known, the transformation may be simplified to a 2D affine transform as:

$$( \begin{matrix}{x}^{′} \\ {y}^{′} \\ 1\end{matrix} ) = ( \begin{matrix}{h}_{01} & {h}_{02} & {h}_{03} \\ {h}_{11} & {h}_{12} & {h}_{13} \\ 0 & 0 & 1\end{matrix} ) ( \begin{matrix}x \\ y \\ 1\end{matrix} ) \qquad ( 3 )$$

In equation (3), (x′,y′) and (x,y) are matched SIFT key-point coordinates from two neighboring images; the 3×3 matrix is a transform matrix H. The transform matrix H may be determined by solving a linear equation established by all matched SIFT key-point coordinates. In some cases, a random sample consensus (RANSAC) approach may be used to achieve a robust estimation. RANSAC is an iterative method to estimate parameters of a mathematical model from a set of observed data, which contains outliers. RANSAC is a non-deterministic algorithm in that the algorithm produces a reasonable result with a certain probability, and the probability increases as the number of iterations increases.

Because images with a same scene may include illumination variances, the photometric transformation 408 may be performed on images to reduce illumination differences between images. The global photometric transformation for a gray image may be written as:

P(I)=aI+b (4)

where I denotes a gray value of a reference image and a and b are the scale and offset parameters, respectively. optimal values for a and b can be estimated in a minimum mean-squared error sense via a group of matched pixel values. Because inner lying SIFT key-point pairs after RANSAC may be robust, pixel values at coordinates of the inner lying SIFT key-point pairs may be used to calculate a and b. The photometric transformation 408 may be extended to color images by setting independent parameters for each color channel.

Although feature-based affine and photometric transformations may efficiently reduce geometric and illumination disparities of images relative to a reference image, inter-image prediction may include smaller local deformations, such as local shifts. To improve inter-image prediction, the block-based motion estimation/compensation 410 may be used. Note that one or more motion parameters, such as matrix H, scale factor a, offset b and the motion vectors of each block, may be encoded and transmitted by the compression module 114.

After the prediction algorithm 402 has performed feature-based prediction, residual signals may be encoded block by block using an entropy encoder. For example, a high-efficiency video coding (HEVC) compatible encoder may be used to perform rate-distortion optimization residual coding. The prediction algorithm 402 may create a predicted image 412 based on performing one or more of the SIFT-based deformation 406, the photometric transformation 408, the block-based motion estimation/compensation, or residual encoding.

In the flow diagrams of FIGS. 2, 4, 5, 6, and 7, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 200, 400, 500, 600, and 700 are described with reference to the architectures 100, 200, and 300 as described herein, although other models, frameworks, systems and environments may implement these processes.

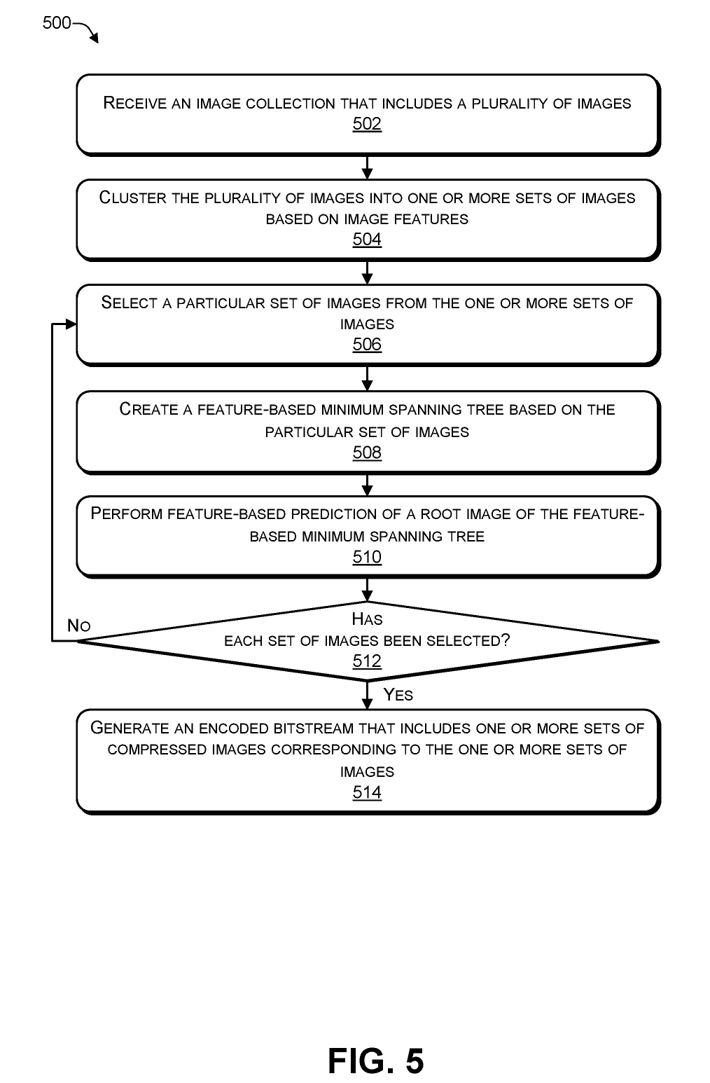

FIG. 5 is a flow diagram of an example process 500 that includes receiving an image collection according to some implementations. The process 500 may be performed by the compression module 114 of FIG. 1.

At 502, an image collection that includes a plurality of images may be received. For example, in FIG. 1, the compression module 114 may receive the image collection 116. For example, a user may instruct the computing device 102 to create a backup of the image collection 116 in a compressed format. As another example, a user may instruct the computing device 102 to create a compressed version of the image collection 116 to enable the user to share one or more images from the image collection with additional computing devices. The computing device 102 may be a personal computing device (e.g., desktop, laptop, tablet, phone, camera, etc.) or a cloud-based storage service.

At 504, the plurality of images may be clustered into one or more sets of images based on image features. For example, in FIG. 1, the images 118 to 120 from the image collection 116 may be clustered into M sets of images 122 to 124.

At 506, a particular set of images may be selected from the one or more sets of images. For example, in FIG. 1, a particular of the set of images 122 to 124 may be selected.

At 508, a feature-based MST may be created based on the particular set of images. For example, in FIG. 3, the feature-based MST 312 may be created using a set of images that includes images 304, 306, 308, and 310.

At 510, a feature-based prediction of a root image of the feature-based MST may be created. For example, in FIG. 4, the predicted image 412 corresponding to the reference image 404 (e.g., a root image of an MST) may be created.

At 512, a determination may be made whether each set of images (e.g., from the one or more sets of images) has been selected. For example, in FIG. 1, a determination may be made whether each of the set of images 122 to 124 has been selected.

In response to determining that each set of images has not been selected, at 512, the process may proceed to 506, where another set of images may be selected. The process may repeat 506, 508, 510, and 512 until all of the one or more sets of images has been selected. For example, in FIG. 1, the compression module 114 may repeatedly select and process a set of images (e.g., one of the set of images 122 to 124) until each of the set of images 122 to 124 has been selected.

In response to determining that each set of images has been selected, at 512, the process may proceed to 506, an encoded bitstream that includes one or more sets of compressed images may be generated, at 514. The one or more sets of compressed images may include compressed images corresponding to the one or more sets of images. For example, in FIG. 1, the compression module 114 may generate the encoded bitstream 138 that includes the M sets of compressed images 134 to 136 corresponding to the M set of images 122 to 124.

Thus, a collection of images may be clustered into sets of images based on features included in each image. At least some of the images in each set of images may be compressed based on SIFT descriptors associated with each image.

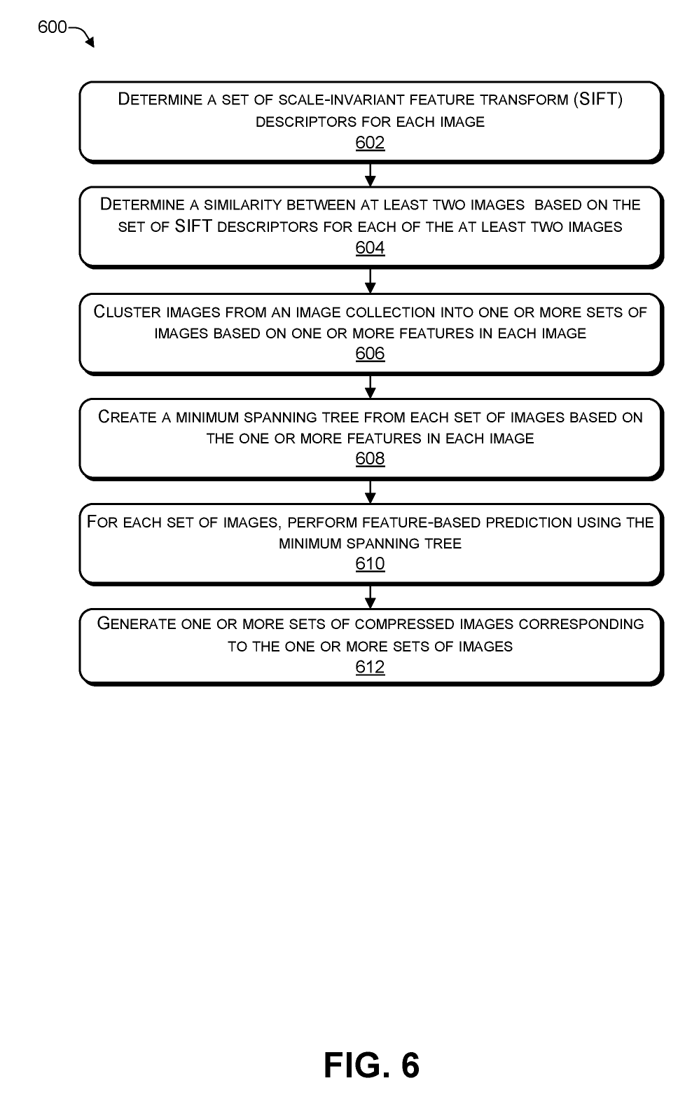

FIG. 6 is a flow diagram of an example process 600 that includes clustering images according to some implementations. The process 600 may be performed by the compression module 114 of FIG. 1.

At 602, a set of scale-invariant feature transform (SIFT) descriptors may be determined for each image in each set of images.

At 604, a similarity between at least two images may be determined based on the set of SIFT descriptors associated with each of the at least two images.

At 606, a plurality of images from an image collection may be clustered into one or more sets of images based on one or more features in each image. For example, in FIG. 1, the images 118 to 120 from the image collection 116 may be clustered into M sets of images 122 to 124 based on one or more features in each image. The features in each image may be described using SIFT descriptors and clustered based on a similarity between images in each set that is measured using the SIFT descriptors.

At 608, an MST may be created from each set of images based on the one or more features in each image. For example, in FIG. 3, the feature-based MST 312 may be created using a set of images that includes images 304, 306, 308, and 310. The MST 312 may be created based on the SIFT descriptors associated with each image.

At 610, for each set of images, feature-based prediction using the MST may be performed. For example, in FIG. 4, the predicted image 412 corresponding to the reference image 404 (e.g., a root image of an MST) may be created.

At 612, one or more sets of compressed images corresponding to the one or more sets of images may be generated. For example, in FIG. 1, the compression module 114 may generate the encoded bitstream 138 that includes the M sets of compressed images 134 to 136 corresponding to the M set of images 122 to 124.

Thus, SIFT descriptors that describe features in an image may be determined for each image in an image collection. The images in the image collection may be clustered into sets of images based on the SIFT descriptors associated with each image. At least some of the images in each set of images may be compressed based on the SIFT descriptors associated with each image.

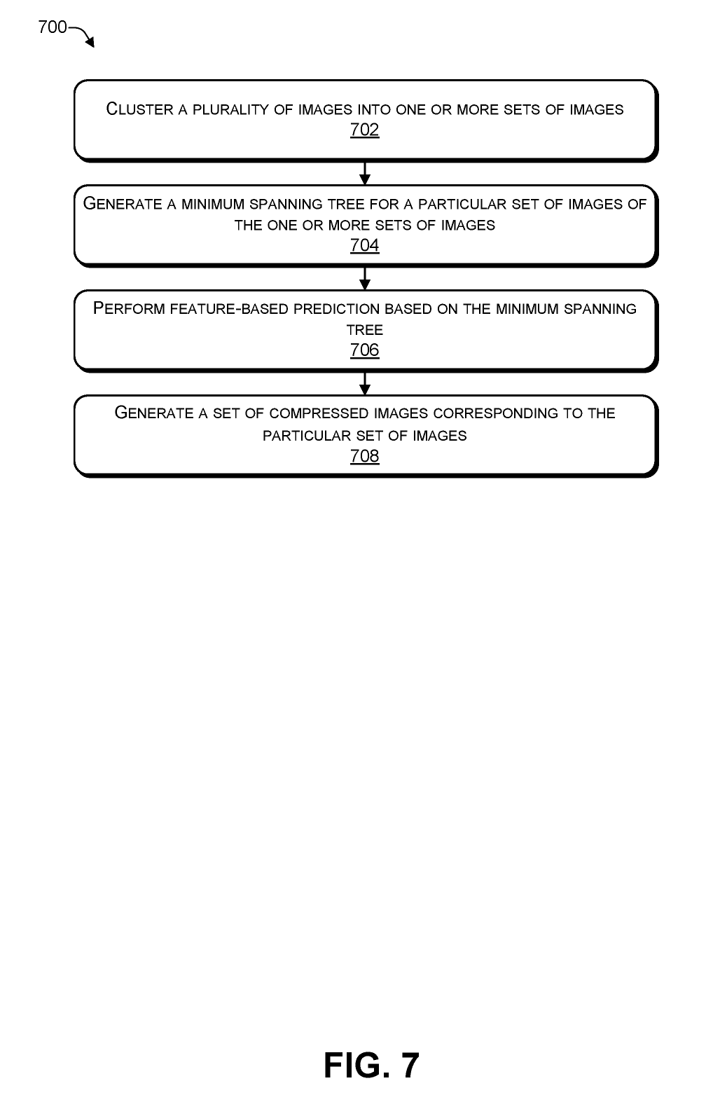

FIG. 7 is a flow diagram of an example process 700 that includes generating a minimum spanning tree according to some implementations. The process 700 may be performed by the compression module 114 of FIG. 1.

At 702, a plurality of images may be clustered into one or more sets of images. For example, in FIG. 1, the images 118 to 120 from the image collection 116 may be clustered into M sets of images 122 to 124.

At 704, an MST may be created based for a particular set of images of the one or more sets of images. For example, in FIG. 3, the feature-based MST 312 may be created using a set of images that includes images 304, 306, 308, and 310.

At 706, feature-based prediction may be performed based on the MST. For example, in FIG. 4, the predicted image 412 corresponding to the reference image 404 (e.g., a root image of an MST) may be created.

At 708, a set of compressed images corresponding to the particular set of images may be generated. For example, in FIG. 1, the compression module 114 may generate the encoded bitstream 138 that includes the M sets of compressed images 134 to 136 corresponding to the M set of images 122 to 124.

Thus, a collection of images may be clustered into sets of images based on features included in each image. An MST may be created for each set of images. At least some of the images in each set of images may be compressed based on SIFT descriptors associated with each image.

### Example Computing Device and Environment

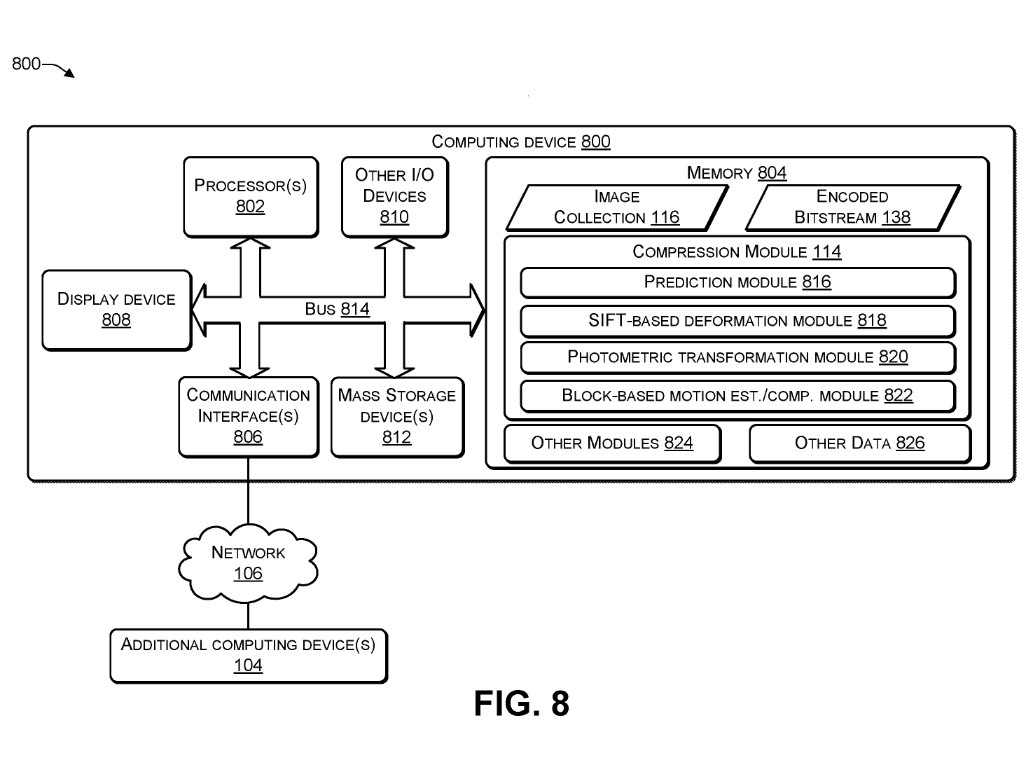

FIG. 8 illustrates an example configuration of a computing device 800 and environment that can be used to implement the modules and functions described herein. For example, the computing device 800 may represent a mobile computing device, such as a tablet computing device, a mobile phone, a camera (e.g., a still picture and/or video camera), another type of portable electronics devices, or any combination thereof. As another example, the computing device 800 can represent a server or a portion of a server used to host various services, such as a search engine capable of searching and displaying images, an image hosting service, an image backup service, an image compression service, etc.

The computing device 800 can include one or more processors 802, a memory 804, communication interfaces 806, a display device 808, other input/output (I/O) devices 810, and one or more mass storage devices 812, able to communicate with each other, such as via a system bus 814 or other suitable connection.

The processors 802 can be a single processing unit or a number of processing units, all of which can include single or multiple computing units or multiple cores. The processor 802 can be implemented as one or more microprocessors, microcomputers, microcontrollers, digital signal processors, central processing units, state machines, logic circuitries, and/or any devices that manipulate signals based on operational instructions. As one non-limiting example, the processor 802 may be one or more hardware processors and/or logic circuits of any suitable type specifically programmed or configured to execute the algorithms and processes described herein. Among other capabilities, the processor 802 can be configured to fetch and execute computer-readable instructions stored in the memory 804, mass storage devices 812, or other computer-readable media.

Memory 804 and mass storage devices 812 are examples of computer storage media for storing instructions, which are executed by the processor 802 to perform the various functions described above. For example, memory 804 can generally include both volatile memory and non-volatile memory (e.g., RAM, ROM, or the like). Further, mass storage devices 812 can generally include hard disk drives, solid-state drives, removable media, including external and removable drives, memory cards, flash memory, floppy disks, optical disks (e.g., CD, DVD), a storage array, a network attached storage, a storage area network, or the like. Both memory 804 and mass storage devices 812 can be collectively referred to as memory or computer storage media herein, and can be capable of storing computer-readable, processor-executable program instructions as computer program code that can be executed by the processor 802 as a particular machine configured for carrying out the operations and functions described in the implementations herein.

The memory 804 may be used to store the image collection 116, the encoded bitstream 138, and the compression module 114 of FIG. 1. The compression module 114 may include a prediction module 816, a SIFT-based deformation module 818, a photometric transformation module 820, and a block-based motion estimation/compensation module 822. The prediction module 816 may perform functions that include the prediction algorithm 402 of FIG. 4. The SIFT-based deformation module 818 may perform functions that include the SIFT-based deformation 406 of FIG. 4. The photometric transformation module 820 may perform functions that include the photometric transformation 408 of FIG. 4. The block-based motion estimation/compensation module 822 may perform functions that include the block-based motion estimation/compensation module 410 of FIG. 4. The memory 804 may also include other modules 824 to perform other functions and other data 826 that includes the results of calculations using the equations described herein.

Although illustrated in FIG. 8 as being stored in memory 804 of computing device 800, the image collection 116, the encoded bitstream 138, the compression module 114, the prediction module 816, the SIFT-based deformation module 818, the photometric transformation module 820, the block-based motion estimation/compensation module 822, the other modules 824 and the other data 826, or portions thereof, can be implemented using any form of computer-readable media that is accessible by the computing device 800. As used herein, “computer-readable media” includes computer storage media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media can embody computer readable instructions, data structures, program modules, or other data in a modulated data signal, such as a carrier wave, or other transmission mechanism. As defined herein, computer storage media does not include communication media.

The computing device 800 can also include one or more communication interfaces 806 for exchanging data with other devices, such as via a network, direct connection, or the like, as discussed above. The communication interfaces 806 can facilitate communications within a wide variety of networks and protocol types, including wired networks (e.g., LAN, cable, etc.) and wireless networks (e.g., WLAN, cellular, satellite, etc.), the Internet and the like. Communication interfaces 806 can also provide communication with external storage (not shown), such as in a storage array, network attached storage, storage area network, or the like.

A display device 808, such as a monitor can be included in some implementations for displaying information and images to users. Other I/O devices 810 can be devices that receive various inputs from a user and provide various outputs to the user, and can include a keyboard, a remote controller, a mouse, a printer, audio input/output devices, and so forth.

Memory 804 can include modules and components to implement the compression module 114 according to the implementations described herein. The memory 804 can include multiple modules (e.g., the modules 114, 816, 818, 820, and 822) to perform various functions associated with compressing/encoding images. The memory 804 may also include other modules 824 that implement other features and other data 826 that includes intermediate calculations and the like. The other modules 824 may include various software, such as an operating system, drivers, communication software, a search engine, images, or the like.

The computing device 800 can use a network 106 to communicate with multiple computing devices, such as the additional computing devices 104. For example, the computing device 800 can be capable of capturing digital images, compressing the digital images using the compression module 114, and sending the compressed digital images to the additional computing devices 106 via the network 106. As another example, the computing device 800 can host a search engine that is capable of search and indexing multiple websites. In response to a search query, the computing device 800 can display images that have been compressed using the compression module.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a hardware-implemented processing device or devices (e.g., CPUs or processors). The program code can be stored in one or more computer-readable memory devices or other computer storage devices. Thus, the processes, components and modules described herein may be implemented by a computer program product.

As used herein, “computer-readable media” includes computer storage media but excludes communication media. Computer storage media includes volatile and non-volatile, removable and non-removable media implemented in any method or technology for storage of information, such as computer readable instructions, data structures, program modules, or other data. Computer storage media includes, but is not limited to, random access memory (RAM), read only memory (ROM), electrically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave. As defined herein, computer storage media does not include communication media.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification.

What is claimed is:

1. A computing device comprising:
one or more processors;
one or more computer-readable storage media storing instructions executable by the one or more processors to perform acts comprising:
receiving an image collection comprising a plurality of images;
clustering the plurality of images into one or more sets of images based on image features;
for each particular set of images of the one or more sets of images:
creating a feature-based minimum spanning tree of images from the particular set of images; and
performing feature-based prediction of a root image of the feature-based minimum spanning tree; and
generating an encoded bitstream that includes one or more sets of compressed images corresponding to the one or more sets of images.

2. The computing device of claim 1, wherein before generating the encoded bitstream that includes the one or more sets of compressed images the acts further comprise:
encoding residual signals using a rate-distortion optimization coding.

3. The computing device of claim 1, wherein clustering the plurality of images into the one or more sets of images based on the image features comprises:
determining a distance between two elements using an average absolute distance of matched 128 dimension gradient vectors; and
selecting a centroid from an image of the image collection, the centroid having a minimum average distance to the other images in a same cluster.

4. The computing device of claim 1, wherein creating the feature-based minimum spanning tree of images from the particular set of images comprises:
creating a directed graph of the images based on a feature-based distance of each of the images from other images; and
generating the feature-based minimum spanning tree of images based on the directed graph of the images.

5. The computing device of claim 4, wherein:
a scale-invariant feature transform distance is used as an edge cost for each of the images in the directed graph.

6. The computing device of claim 1, wherein performing the feature-based prediction of the root image of the feature-based minimum spanning tree comprises:
encoding the root image as an intra-image frame without prediction;
reconstructing the root image; and
performing inter-image prediction to generate a prediction image for coding other images.

7. A computer readable storage device storing instructions executable by one or more processors to perform acts comprising:
clustering images from an image collection into one or more sets of images based on one or more features in each image;
creating a minimum spanning tree of images from each set of the one or more sets of images based on the one or more features in each image;
for each of the one or more sets of images, performing feature-based prediction using the minimum spanning tree of images; and
generating one or more sets of compressed images corresponding to the one or more sets of images.

8. The computer readable memory device of claim 7, wherein performing the feature-based prediction using the minimum spanning tree of images comprises:
for each image in the one or more sets of images, performing a scale invariant feature transform based deformation to reduce geometric distortions caused by one or more locations and one or more view angles.

9. The computer readable memory device of claim 7, wherein performing the feature-based prediction using the minimum spanning tree of images comprises:
performing a photometric transformation to reduce variations in brightness among images in each of the one or more sets of images.

10. The computer readable memory device of claim 7, wherein performing the feature-based prediction using the minimum spanning tree of images comprises:
performing block-based motion estimation and compensation.

11. The computer readable memory device of claim 7, the acts further comprising:
determining a set of scale-invariant feature transform descriptors for each image in each set of the one or more sets of images; and
determining a similarity between at least two images in each set of the one or more sets of images based on the set of scale-invariant feature transform descriptors for each of the at least two images.

12. The computer readable memory device of claim 7, wherein performing the feature-based prediction using the minimum spanning tree of images further comprises:
performing global-level alignment of images in each set of the one or more sets of images to reduce scale distortion and rotation distortion differences between the images.

13. A method performed under control of one or more processors that are configured with instructions, the method comprising:
clustering a plurality of images into one or more sets of images;
generating a minimum spanning tree for a particular set of images of the one or more sets of images;
performing feature-based prediction based on the minimum spanning tree; and
generating a set of compressed images corresponding to the particular set of images.

14. The method of claim 13, wherein clustering the plurality of images into the one or more sets of images comprises:
creating a set of scale-invariant feature transform descriptors for each image of the plurality of images; and
determining a difference between at least two images based on a distance between the set of scale-invariant feature transform descriptors associated with each of the at least two images.

15. The method of claim 14, wherein generating the minimum spanning tree for the particular set of images of the one or more sets of images comprises:
generating a directed graph based on feature-based distances between images; and
generating the minimum spanning tree based on a structure of the directed graph.

16. The method of claim 15, wherein:
an edge cost between nodes of the directed graph is based on the set of scale-invariant feature transform descriptors for each image of the particular set of images.

17. The method of claim 13, wherein performing the feature-based prediction based on the minimum spanning tree comprises:
performing global-level alignment for each image in the particular set of images; and
performing block-level motion estimation for each image in the particular set of images.

18. The method of claim 17, wherein performing the global-level alignment for each image in the particular set of images comprises:
performing a scale-invariant feature transform based deformation to reduce geometric distortions of at least one image in the particular set of images.

19. The method of claim 17, wherein performing the global-level alignment for each image in the particular set of images comprises:
performing a photometric transformation to reduce variations in brightness among images in the particular set of images.

20. The method of claim 17, wherein performing the block-level motion estimation for each image in the particular set of images comprises:
performing block-based motion estimation and compensation to reduce local shifts.
